(19) United States
(12) Patent Application Publication
(10) Pub. No.: US 2025/0310268 A1
(43) Pub. Date: Oct. 2, 2025

(54) PACKET PROCESSING METHOD AND APPARATUS

(71) Applicant: VIVO MOBILE COMMUNICATION CO., LTD., Guangdong (CN)

(72) Inventor: Li CHEN, Guangdong (CN)

(73) Assignee: VIVO MOBILE COMMUNICATION CO., LTD., Guangdong (CN)

(21) Appl. No.: 19/232,070

(22) Filed: Jun. 9, 2025

Related U.S. Application Data
(63) Continuation of application No. PCT/CN2023/136031, filed on Dec. 4, 2023.

(30) Foreign Application Priority Data
Dec. 9, 2022 (CN) 202211585882.3

(51) Int. Cl. H04L 47/32; H04L 47/283; H04W 28/06

(52) U.S. Cl. CPC H04L 47/32; H04L 47/283; H04W 28/06

(57) ABSTRACT

A packet processing method and apparatus. The packet processing method includes: in a case that a first condition is met, a first protocol entity prioritizes transmission of a target packet or prioritizes discarding of the target packet, where the first condition includes at least one of the following: the first protocol entity receives first indication information from a second protocol entity; and the first protocol entity does not receive second indication information from the second protocol entity; where the target packet is a packet corresponding to the first indication information or the second indication information, and the second protocol entity is an upper-layer protocol entity of the first protocol entity. In the embodiments of this application, data transmission efficiency can be improved.

### CROSS-REFERENCE TO RELATED APPLICATIONS

This application is a continuation of International Application No. PCT/CN2023/136031 filed on Dec. 4, 2023, which claims priority to Chinese Patent Application No. 202211585882.3 filed on Dec. 9, 2022, which are incorporated herein by reference in their entireties.

### TECHNICAL FIELD

This application pertains to the field of communication technologies, and in particular, relates to a packet processing method and apparatus.

### BACKGROUND

In a packet discard/drop mechanism, in a related technology, a packet data convergence protocol layer of a terminal determines, based on a configured discard timer (DiscardTimer) of the packet data convergence protocol layer, whether a packet is discarded, and a packet submitted to a lower-layer protocol entity is not affected, but scheduling or discarding of a packet of the lower-layer protocol entity needs to be optimized.

### SUMMARY

Embodiments of this application provide a packet processing method and apparatus, which can improve data transmission efficiency.

According to a first aspect, an embodiment of this application provides a packet processing method, including:
in a case that a first condition is met, prioritizing, by a first protocol entity, transmission of a target packet, or prioritizing, by the first protocol entity, discarding of the target packet; where
the first condition includes at least one of the following:
the first protocol entity receives first indication information from a second protocol entity; and
the first protocol entity does not receive second indication information from the second protocol entity; where
the target packet is a packet corresponding to the first indication information or the second indication information; and
the second protocol entity is an upper-layer protocol entity of the first protocol entity.

According to a second aspect, an embodiment of this application provides a packet processing apparatus, including:
a first processing module, configured to: in a case that a first condition is met, prioritize transmission of a target packet or prioritize discarding of the target packet; where
the first condition includes at least one of the following:
a first protocol entity receives first indication information from a second protocol entity; and
the first protocol entity does not receive second indication information from the second protocol entity; where
the target packet is a packet corresponding to the first indication information or the second indication information; and
the second protocol entity is an upper-layer protocol entity of the first protocol entity.

According to a third aspect, an embodiment of this application provides a packet processing method, including:
in a case that a third condition is met, sending, by a second protocol entity, first indication information to a first protocol entity, or skipping sending, by the second protocol entity, second indication information to the first protocol entity, where the first indication information is used to instruct the first protocol entity to prioritize transmission of a target packet or prioritize discarding of the target packet, and the second indication information is used to instruct the first protocol entity to prioritize transmission of another packet except the target packet or prioritize discarding of the another packet; where
the third condition includes at least one of the following:
a preset sending period is reached;
the second protocol entity discards the target packet;
a delay of the target packet exceeds a preset delay;
the target packet is not discarded while the delay of the target packet exceeds the preset delay;
a packet arrives at the second protocol entity;
an occupation rate of a buffer of the second protocol entity reaches a preset threshold or a preset degree of congestion; and
the second protocol entity submits a packet to the first protocol entity; where
the target packet is a packet corresponding to the first indication information or the second indication information; and
the second protocol entity is an upper-layer protocol entity of the first protocol entity.

According to a fourth aspect, an embodiment of this application provides a packet processing apparatus, including:
a second processing module, configured to: in a case that a third condition is met, send first indication information to a first protocol entity or skip sending second indication information to the first protocol entity, where the first indication information is used to instruct the first protocol entity to prioritize transmission of a target packet or prioritize discarding of the target packet, and the second indication information is used to instruct the first protocol entity to prioritize transmission of another packet except the target packet or prioritize discarding of the another packet; where
the third condition includes at least one of the following:
a preset sending period is reached;
a second protocol entity discards the target packet;
a delay of the target packet exceeds a preset delay;
the target packet is not discarded while the delay of the target packet exceeds the preset delay;
a packet arrives at the second protocol entity;
an occupation rate of a buffer of the second protocol entity reaches a preset threshold or a preset degree of congestion; and
the second protocol entity submits a packet to the first protocol entity; where
the target packet is a packet corresponding to the first indication information or the second indication information; and
the second protocol entity is an upper-layer protocol entity of the first protocol entity.

According to a fifth aspect, an embodiment of this application provides a packet processing apparatus, including a processor and a memory. The memory stores a program or instructions capable of running on the processor. When the program or the instructions are executed by the processor, the steps of the packet processing method according to the first aspect are implemented, or the steps of the packet processing method according to the third aspect are implemented.

According to a sixth aspect, an embodiment of this application provides a readable storage medium. The readable storage medium stores a program or instructions, and when the program or the instructions are executed by a processor, the steps of the method according to the first aspect are implemented, or the steps of the method according to the third aspect are implemented.

According to a seventh aspect, an embodiment of this application provides a chip. The chip includes a processor and a communication interface, the communication interface is coupled to the processor, and the processor is configured to run a program or instructions, to implement the method according to the first aspect or the method according to the second aspect.

According to an eighth aspect, a computer program product/program product is provided. The computer program product/program product is stored in a storage medium, and the computer program/program product is executed by at least one processor to implement the steps of the packet processing method according to the first aspect or the steps of the packet processing method according to the third aspect.

In the embodiments of this application, a first protocol entity schedules and processes a target packet based on first indication information or second indication information of a second protocol entity, so that scheduling and processing of the target packet can be optimized, and data transmission efficiency can be improved, thereby improving a capacity of a communication system and reducing power consumption of a terminal.

### BRIEF DESCRIPTION OF DRAWINGS

FIG. 1 is a block diagram of a wireless communication system to which embodiments of this application are applicable;

FIG. 2 is a schematic flowchart of a packet processing method on a side of a first protocol entity according to an embodiment of this application;

FIG. 3 is a schematic flowchart of a packet processing method on a side of a second protocol entity according to an embodiment of this application;

FIG. 4 is a schematic diagram of a structure of a packet processing apparatus on a side of a first protocol entity according to an embodiment of this application;

FIG. 5 is a schematic diagram of a structure of a packet processing apparatus on a side of a second protocol entity according to an embodiment of this application; and

FIG. 6 is a schematic diagram of a structure of a communication device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th generation (6G) communication system.

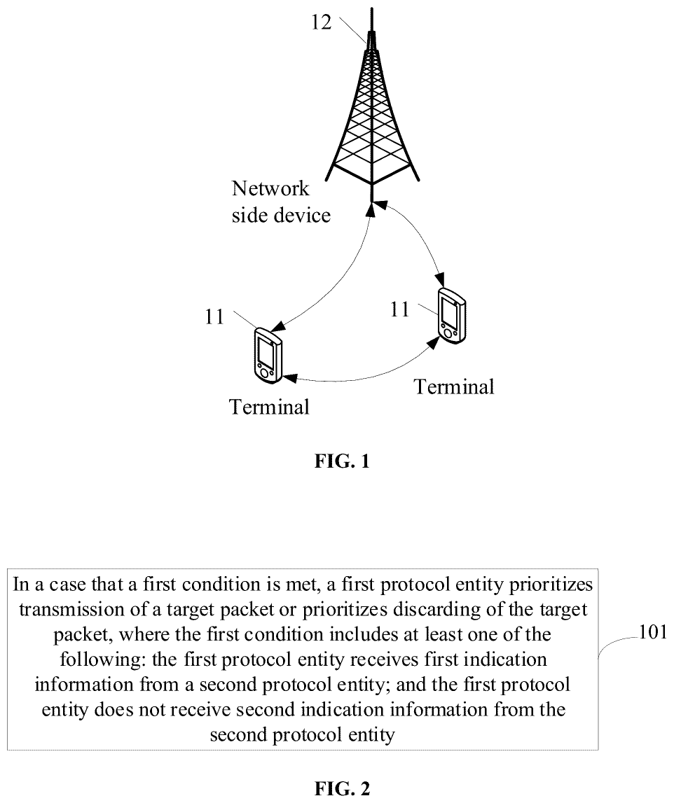

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer that is also referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle-mounted user equipment (VUE), pedestrian user equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a WiFi node, and the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another proper term in the art. The base station is not limited to a specific technical vocabulary provided that a same technical effect is achieved. It should be noted that in the embodiments of this application, a base station in an NR system is merely used as an example for description, but does not limit a specific type of the base station.

For a VR service, relatively dense small packets are mainly transmitted on an uplink. The small packets may carry information such as a gesture and control, and serve as input and reference for downlink presentation data. On a downlink, multimedia data such as video and audio are mainly transmitted. Through timely receiving and presentation of the multimedia data, immersive experience is provided to a user. Downlink video data is used as an example. A packet period or a quasi-periodicity arrives, a data rate may reach dozens or even megabits per second (Mbps), a typical value of a frame rate (FPS) is 60 or 120, and an interval between adjacent packets is approximately 1/FPS seconds. The data generally needs to be successfully transmitted within 10 ms on an air interface, and a transmission success rate is required to be not less than 99% or even 99.9%.

For an AR service, in addition to the foregoing transmission of dense small packets, on an uplink, multimedia data such as video and audio may also be transmitted. A service characteristic of the AR service is similar to that of the downlink. Generally, a data rate is relatively low, for example, a maximum of dozens of Mbps, and a time limit of air interface transmission may also be relaxed. For example, transmission generally needs to be performed successfully within 60 ms. Data transmission characteristics of the downlink are basically the same as those of the VR service.

The user wants to interact and operate in an extended reality, where the operation and interaction include an action, a gesture, and a body reaction. A degree of freedom (DoF) describes a quantity of independent parameters used to define movement of a viewport in 3D space.

In an application scenario of extended reality (XR), in virtual reality experience, the user may obtain information of a new angle of view by performing actions such as turning the head. In this case, the head-turning action of the XR user may be notified to a base station by sending an uplink signal. After receiving the uplink signal, the base station schedules required downlink data for the XR user for use.

An XR service mainly includes video data, audio data, and some control signaling and special data that have a control function. In a wireless network, XR service transmission mainly relates to uplink and downlink video/audio data transmission and interaction between user equipment (UE, also referred to as a terminal) and a wireless access network (such as LTE/NR). When transmitting video and audio data, the UE needs to transmit, in an uplink, some control signaling and special data that have a control function by using a wireless network, for generation, processing, and downlink wireless transmission of video and audio service data in an XR service sent by a control network to the UE.

The control information and special data that have a control function include some service control data generated by a UE XR application encoder and control data information included in a service transmission protocol. For example,
from a perspective of an application layer, the control information and special data may include (but are not limited to):
an intra-frame encoding frame (I frame), an instantaneous decoding refresh (IDR) frame, or a non-field of view (non-FOV) frame generated by a video encoder; and
user behavior data collected by a sensor, such as pose/control data. The network may determine user behavior by receiving the data, for example, an action such as the foregoing rotation of the head of the user, so as to adjust sent video data content.

For a perspective of a transmission protocol layer, the control information and special data may include:
transmission control protocol (TCP) acknowledgement (ACK) signaling (TCP feedback) for downlink audio/video service transmission, where a network needs to determine, based on whether a corresponding video/audio frame has been acknowledged by the UE, whether a subsequent frame can continue to be sent; and
real-time transport control protocol (RTCP) acknowledgement ACK (ACK) signaling, which is used to control control signaling of real-time data transmission, and acknowledge that a real-time data transmission requirement of a service is synchronized with time.

The network usually needs to receive, from the UE in a timely and reliable manner, these control signaling and special data that have a control function, to obtain a transmission status of a current service and related necessary control information. An application server needs to further generate, based on the information, video and audio service data that needs to be subsequently transmitted, and transfer the video and audio service data to the wireless network for processing and transmission, and finally the service data is sent to the UE in a downlink manner.

Based on the discussion of the XR standard item, the XR service is a quasi-periodic service, that is, service packets arrive at equal intervals, and the interval is a small floating-point type (non-positive integer) (for example, 30 FPS (FPS refers to a quantity of frames per second)→33.33 ms, 60 FPS→16.67 ms, or 120 FPS→8.33 ms). In addition, the XR service has a high requirement for a delay, and an air interface transmission packet delay budget (PDB) needs to be approximately 10 ms.

However, because a service sent from a server end to a base station end needs to have a transmission delay or the like, some jitter in terms of time that reaches a base station side occurs in an XR service packet, that is, on a basis of a quasi-period, an offset in a specific range exists for packet incoming time of each service, and the offset is referred to as jitter. The offset of the jitter complies with truncated Gaussian distribution, with a range being ±4 ms for a time position reached by a quasi-periodic service packet.

For example, time at which a packet reaches the base station end in a quasi-period is n (a unit is, for example, ms). Due to impact of jitter, actual arrival time of the packet is n+j, where j is a size of jitter, and for example, jitter is −1 ms, it indicates that actual arrival time of a packet that originally needs to arrive at time n is n−1 ms.

To facilitate a network side in performing uplink scheduling based on uplink to-be-transmitted data, starting from LTE, a buffer status report (BSR) reporting mechanism is introduced, and the UE reports, to a base station, an uplink to-be-transmitted data amount corresponding to each logical channel group. This mechanism is basically used in NR.

A granularity for reporting of a BSR is a logical channel group (LCG). Each established logical channel may be configured with a home logical channel group, and NR supports configuring a maximum of eight logical channel groups for single UE at the same time.

The BSR is triggered based on the following events:
(1) New uplink to-be-transmitted data arrives on a specific logical channel of a specific logical channel group, and a priority of the logical channel is higher than a priority of a previous logical channel that has uplink to-be-transmitted data, or no logical channel has uplink to-be-transmitted data before the new data arrives. In this case, a regular BSR is triggered.
(2) When a specific uplink newly transmitted transport block (TB) is organized, a quantity of padding bits in the newly transmitted TB is greater than or equal to a quantity of bits occupied by (a single BSR medium access control control element (MAC CE)+a subheader corresponding to the single BSR medium access control control element) (that is, the padding bits in the newly transmitted TB may further accommodate bits corresponding to the single BSR MAC CE). In this case, a padding BSR is triggered.
(3) A retxBSR-Timer timer expires, and uplink to-be-transmitted data exists on at least one logical channel. In this case, a regular BSR is triggered.
(4) A periodicBSR-Timer timer expires. In this case, a periodic BSR is triggered.

When the regular BSR is triggered and there is no uplink resource used for a new transmission, the UE triggers a scheduling request (SR) to request an uplink new transmission resource from the network through physical uplink control channel (PUCCH) transmission or random access.

When the periodic BSR is triggered, the UE includes one BSR MAC CE in a constructed uplink TB only when there is an uplink new transmission resource, but does not actively request the uplink new transmission resource from the network by triggering an SR.

When the padding BSR is triggered, the UE directly includes one BSR MAC CE in an uplink new transmission TB.

This embodiment relates to a wireless communication access stratum (AS) uplink data processing and sending procedure of the UE. Descriptions of related main protocol layers and related functions in a conventional technology are as follows.

### (1) Packet Data Convergence Protocol (PDCP) Layer and Radio Bearer:

Service data generated by an application (APP) layer of the UE is classified into different service data flows based on corresponding quality-of-service (QOS) requirements, and each service data flow corresponds to a same QoS requirement or similar QoS requirements. In an NR system, the service data flow corresponds to one quality of service flow (QOS flow), and in an LTE system, the service data flow corresponds to one evolved packet system (EPS) bearer.

Service data is transmitted to an AS layer in a form of a packet, and is further mapped, at the AS layer, to a radio bearer based on a QoS flow (NR) or an EPS bearer (LTE) corresponding to the packet. One radio bearer includes one PDCP entity (PDCP protocol layer processing entity), one radio link control (RLC) entity (PDCP protocol layer processing entity), and a corresponding logical channel (located at a MAC protocol layer).

After a packet transferred to the AS layer is mapped to a radio bearer, the packet is transferred to a corresponding PDCP entity in a form of a service data unit (SDU) for processing. The PDCP entity generates a corresponding PDCP protocol data unit (PDU) for each arriving PDCP SDU, and sets a PDCP sequence number (SN) to indicate a transmission sequence corresponding to each PDCP SDU and a corresponding PDCP PDU in the PDCP entity. A value of the PDCP SN is set based on an order in which the PDCP SDU is transmitted to the PDCP entity, and an order of a PDCP SDU that arrives first is before that of a PDCP SDU that is transferred later. Specifically, the PDCP entity maintains an internal variable TX_NEXT, which represents a total quantity of PDCP PDUs transmitted by the PDCP entity, and is used to set the value of the PDCP SN. When the PDCP entity is established, the PDCP entity initializes the internal variable to 0. Each time a PDCP SDU is transferred from an upper layer to a corresponding PDCP entity, the PDCP entity actually sets an SN of a PDCP PDU corresponding to the PDCP SDU to TX_NEXT, and increases TX NEXT by 1. Then, the PDCP entity adds a header file to each PDCP SDU to generate a corresponding PDCP PDU, where the PDCP PDU includes an SN value that is set for the PDCP PDU. The PDCP entity generally transfers PDCP PDUs in sequence to a lower protocol layer (RLC) for subsequent processing and transmission based on a sequence of SNs included in the PDCP PDU. The SN is a sequence number, and indicates a transmission order of each PDCP SDU. A general principle is that a PDCP SDU that arrives at the PDCP entity earlier leads to a smaller SN value and earlier transmission.

### (2) Radio Link Layer (RLC) Layer

A PDCP PDU transferred from the PDCP entity to a corresponding RLC entity is cached in a buffer of the UE as a to-be-transmitted RLC SDU and is further processed by the RLC entity. Specifically, when a specific transmission resource is allocated to a logical channel corresponding to an RLC entity, the RLC entity determines, based on an amount of data that can be accommodated in the allocated transmission resource and an amount of data of a to-be-transmitted RLC SDU in the buffer, which RLC SDUs may be multiplexed into the allocated transmission resource for transmission.

For one or more RLC SDUs that are determined by the RLC entity and that can be completely multiplexed into the allocated transmission resource, the RLC entity separately adds corresponding RLC header files to the RLC SDUs, generates corresponding RLC PDUs, and transfers the corresponding RLC PDUs to a lower protocol layer (MAC) for subsequent processing and transmission. After the foregoing complete RLC PDUs are reused, if there are still some remaining resources that are not enough to reuse a complete RLC SDU (that is, an amount of data that can be supported by the resource is less than an amount of data required for multiplexing a next RLC SDU), the RLC entity performs segmentation processing, that is, adds a header file to a part of data of a next to-be-transmitted RLC SDU, generates an RLC PDU, and transfers the RLC PDU to the next protocol layer for subsequent processing and transmission.

For this segmented RLC SDU, a remaining part remains in the buffer of the UE, and is transmitted until a next uplink transmission resource arrives.

### (3) Medium Access Control (MAC) Layer and Logical Channel

An RLC entity corresponding to each radio bearer further corresponds to one logical channel at the MAC layer. After an uplink transmission resource grant (Uplink grant) is allocated to the UE, a MAC entity of the UE further allocates current uplink transmission resources between a plurality of logical channels. Specifically, each logical channel corresponds to one logical channel priority. The MAC entity of the UE allocates, based on a resource allocation mechanism of logical channel prioritization (LCP), an available transmission resource for current uplink transmission to each logical channel in descending order of logical channel priorities, where the available transmission resource corresponds to an amount of data that can be transmitted on each logical channel.

As described above, based on a transmission resource to which each logical channel is allocated, a corresponding RLC entity transfers one or more RLC PDUs to corresponding logical channels at the MAC layer. The MAC layer uses an RLC PDU obtained by each logical channel from the RLC entity as a to-be-transmitted MAC SDU, adds a MAC header file corresponding to a corresponding logical channel to form a MAC subPDU corresponding to the logical channel, and multiplexes the MAC subPDU into an entire transmission resource as data sent in current uplink transmission of the logical channel. MAC subPDUs of a plurality of logical channels are combined to finally form a MAC PDU that is used as a packet to be sent in an uplink at this time and is transmitted to the network by using a wireless signal.

It should be noted that, because the RLC entity performs segmentation processing (as described above) on the RLC SDU, for each uplink transmission resource obtained by the UE, the UE needs to first multiplex, to the resource for transmission, a remaining part of an RLC SDU that has been segmented in previous transmission and has not been completely transmitted, and then can transmit a subsequent packet corresponding to another RLC SDU.

In general, in an existing LTE network and NR network, for data on each radio bearer, the UE generally implements the foregoing uplink data processing and transmission process by using a “first arrived, first transmitted” principle. Specifically, for each radio bearer, the UE processes, at each of the foregoing protocol layers, packets (SDUs) based on a sequence in which the packets are transferred to a corresponding entity at the current layer, and transfers processed packets (PDU) to a next protocol layer in sequence. In other words, for a packet that is first transferred to an AS layer, a corresponding PDCP entity sets a smaller PDCP SN value for the packet, so that the packet is processed by each of the foregoing protocol layers earlier and is multiplexed to an uplink resource earlier for transmission; and a larger PDCP SN value is allocated to a packet that arrives later, and this packet is usually processed, multiplexed, and transmitted by each of the foregoing protocol layers after a packet that arrives earlier. This also means that for packets mapped to each radio bearer, the UE ultimately performs a sequential transmission mechanism in a sequence in which the packets arrive at the AS.

The principle is mainly adopted based on consideration of a transmission delay: Because in an existing wireless network, data transmission delay requirements of all radio bearers are basically the same, and in an existing wireless network, a UE AS layer is not allowed to obtain specific content of each packet, and distinguished processing for the packets cannot be performed. Therefore, performing uplink processing, scheduling, and transmission of packets based on a sequence of arrival of the packets is a relatively reasonable manner in the conventional technology from a perspective of ensuring a delay as far as possible.

For a discard timer at a PDCP layer, only a data radio bearer (DRB) has a discard timer. A transmit side starts a new timer for each SDU from an upper layer, and discards the SDU after the timer expires, to prevent a sending buffer from being congested. Specific duration of this timer is configured by upper-layer RRC. Specifically, when a PDCP SDU delivered by an upper layer is received, a PDCP entity on a transmit side starts a discard timer associated with the PDCP SDU. When the discard timer associated with the PDCP SDU expires, or the PDCP SDU is successfully transmitted (that is, a PDCP status report acknowledges successful transmission), the PDCP entity on the transmit side needs to discard the PDCP SDU and a corresponding PDCP data PDU. If the PDCP data PDU has been delivered to a lower layer, it is required to instruct the lower layer to discard the PDCP data PDU. For a signaling bearer (SRB), when the upper layer requests to discard one PDCP SDU, the PDCP entity needs to discard all stored PDCP SDUs and PDCP PDUs. Certainly, if a PDCP SDU already associated with a PDCP SN is discarded, an SN gap in the transmitted PDCP data PDU is brought. This increases a corresponding PDCP re-ordering delay in a receiving PDCP entity. In this case, it is ensured, based on implementation of the UE, how to minimize the SN gap after the SDU is discarded.

In a packet discard/drop mechanism, in a conventional technology, a PDCP layer determines, based on a discard timer (DiscardTimer) of a configured PDCP layer, whether a packet is to be discarded. A packet submitted to a low-layer protocol entity is not affected. Considering that services such as XR and CG have high requirements for both a delay and a packet loss rate, based on a delay of a packet and auxiliary of an upper-layer protocol entity, optimization of scheduling or discarding of the lower-layer protocol entity can effectively improve data transmission efficiency.

A packet processing method provided in the embodiments of this application is described in detail below with reference to the accompanying drawings by using specific embodiments and application scenarios thereof.

An embodiment of this application provides a packet processing method. As shown in FIG. 2, the method includes the following steps.

Step 101: In a case that a first condition is met, a first protocol entity prioritizes transmission of a target packet or prioritizes discarding of the target packet.

The first condition includes at least one of the following:
the first protocol entity receives first indication information from a second protocol entity; and
the first protocol entity does not receive second indication information from the second protocol entity; where
the target packet is a packet corresponding to the first indication information or the second indication information; and
the second protocol entity is an upper-layer protocol entity of the first protocol entity, the second protocol entity includes at least one of the following: an application layer entity, a non-access stratum (NAS) entity, a packet data convergence protocol PDCP entity, a radio link control RLC entity, and a medium access control MAC entity, and the first protocol entity includes at least one of the following: an RLC entity, a MAC entity, and a physical (PHY) layer entity.

In this embodiment of this application, the first protocol entity schedules and processes the target packet based on the first indication information or the second indication information from the second protocol entity, so that scheduling and processing of the target packet can be optimized, and data transmission efficiency can be improved, thereby improving a capacity of a communication system and reducing power consumption of a terminal.

In some embodiments, that the first protocol entity prioritizes transmission of the target packet or prioritizes discarding of the target packet includes:
scheduling a new transmission, where specifically, regardless of whether the target packet is correctly transmitted, a new transmission is scheduled in this case, so that overall transmission efficiency can be improved;
discarding the target packet;
prioritizing scheduling of the target packet;
increasing a priority of a logical channel (LCH) of the target packet, so that transmission of the target packet can be prioritized;
adjusting the target packet to a higher-priority LCH, so that transmission of the target packet can be prioritized; and
adjusting a modulation and coding scheme (MCS) level of the target packet, including: adjusting the MCS level of the target packet to a lower level, to improve transmission reliability of the target packet; or adjusting the MCS level of the target packet to a higher level, to improve transmission efficiency of the target packet.

In this embodiment, the first protocol entity may prioritize transmission of the target packet or prioritize discarding of the target packet based on auxiliary information of the upper-layer protocol entity (that is, the second protocol entity), so that transmission or discarding of the target packet can be optimized, and data transmission efficiency can be improved.

In some embodiments, the method further includes:
in a case that a second condition is met, prioritizing, by the first protocol entity, transmission of another packet except the target packet, or prioritizing, by the first protocol entity, discarding of the another packet; where
the second condition includes at least one of the following:
the first protocol entity does not receive the first indication information from the second protocol entity; and
the first protocol entity receives the second indication information from the second protocol entity.

In this embodiment of this application, the first protocol entity schedules and processes another packet based on the first indication information or the second indication information from the second protocol entity, so that scheduling and processing of the another packet can be optimized, and data transmission efficiency can be improved, thereby improving a capacity of a communication system and reducing power consumption of a terminal.

In some embodiments, that the first protocol entity prioritizes transmission of or prioritizes discarding of the another packet includes:
scheduling a retransmission, specifically, scheduling a retransmission of the corresponding target packet, so that transmission reliability of the target packet can be improved;
reserving the target packet;
not discarding the target packet;
prioritizing scheduling of the another packet;
decreasing a priority of an LCH of the target packet, so that transmission of the another packet can be prioritized;
adjusting the target packet to a lower-priority LCH, so that transmission of the another packet can be prioritized; and
adjusting an MCS level of the target packet, including: adjusting the MCS level of the target packet to a lower level, to improve transmission reliability of the target packet; or adjusting the MCS level of the target packet to a higher level, to improve transmission efficiency of the target packet.

In this embodiment, the first protocol entity may prioritize transmission of the another packet or prioritize discarding of the another packet based on auxiliary information of the upper-layer protocol entity (that is, the second protocol entity), so that transmission or discarding of the another packet except the target packet can be optimized, and data transmission efficiency can be improved.

In this embodiment, the target packet is a packet corresponding to the first indication information or the second indication information, or the target packet is a packet indicated by the first indication information or the second indication information, and a packet identifier of the target packet may be carried in the first indication information or the second indication information, so that the first protocol entity determines the target packet.

In some embodiments, the first indication information indicates at least one of the following:
the target packet can be discarded, so that the first protocol entity may prioritize discarding of the target packet based on the first indication information, thereby ensuring transmission validity and saving system resources; or the first protocol entity may prioritize transmission of the target packet, to ensure reliability of packet transmission; and when the first indication information is not received, the first protocol entity may prioritize transmission of the another packet, to ensure reliability of packet transmission, or the first protocol entity may prioritize discarding of the another packet, to ensure transmission validity and save system resources;
the target packet is discarded, that is, the second protocol entity has discarded the target packet, so that the first protocol entity may prioritize discarding of the target packet based on the first indication information, to ensure transmission validity and save system resources; or the first protocol entity may prioritize transmission of the target packet, to ensure reliability of packet transmission; and when the first indication information is not received, the first protocol entity may prioritize transmission of the another packet, to ensure reliability of packet transmission, or the first protocol entity may prioritize discarding of the another packet, to ensure transmission validity and save system resources;
a delay of the target packet exceeds a preset delay, which indicates that transmission of the target packet has been delayed, and the first protocol entity may prioritize discarding of the target packet based on the first indication information, to ensure transmission validity and save system resources; or the first protocol entity may prioritize transmission of the target packet, to ensure reliability of packet transmission; and when the first indication information is not received, the first protocol entity may prioritize transmission of the another packet, to ensure reliability of packet transmission, or the first protocol entity may prioritize discarding of the another packet, to ensure transmission validity and save system resources;
transmission of the target packet cannot be completed within a preset delay, which indicates that a delay of the target packet cannot be ensured, so that the first protocol entity may prioritize discarding of the target packet based on the first indication information, to ensure transmission validity and save system resources; or the first protocol entity may prioritize transmission of the target packet, to ensure reliability of packet transmission; and when the first indication information is not received, the first protocol entity may prioritize transmission of the another packet, to ensure reliability of packet transmission, or the first protocol entity may prioritize discarding of the another packet, to ensure transmission validity and save system resources;
feedback information corresponding to the target packet, including an acknowledgement message (ACK) message or a negative acknowledgement (NACK) message, where when the feedback information corresponding to the target packet is an ACK, discarding of the target packet may be prioritized, to save system resources, and when the feedback information corresponding to the target packet is a NACK, transmission of the target packet is prioritized, to ensure reliability of packet transmission; and when the first indication information is not received, transmission of the another packet may be prioritized, to ensure reliability of packet transmission, or discarding of the another packet is prioritized, to ensure transmission validity and save system resources; and
a remaining delay of the target packet, where transmission of the target packet may be prioritized or discarding of the target packet may be prioritized based on the remaining delay of the target packet, for example, when the remaining delay of the target packet reaches a specific preset value, it indicates that this target packet is to expire, and transmission of this target packet may be prioritized, to ensure reliability of packet transmission, where the preset value may be agreed upon in a protocol or configured by a network; or when the remaining delay of the target packet reaches another preset value, it indicates that this target packet has already expired for a receive end, and to ensure transmission validity and save system resources, the target packet may be discarded; and when the first indication information is not received, transmission of the another packet may be prioritized, to ensure reliability of packet transmission, or discarding of the another packet is prioritized, to ensure transmission validity and save system resources; and
a characteristic of the target packet, including importance, a priority, a dependency, a PDB/packet set delay budget (PSDB), a size (size), a packet error rate (PDU/PDU set error rate, PER/PSER), a latency, a quality of service (QOS) parameter (such as information related to a QoS flow identifier (ID), a 5G QoS identifier (5QI)), and the like. In a specific example, when the first indication information includes importance of the target packet and indicates that the importance of the target packet is medium, discarding of the target packet is prioritized, and when the first indication information includes importance of the target packet and indicates that the importance of the target packet is high, transmission of the target packet is prioritized, so that data transmission can be optimized based on the importance of the target packet, thereby improving data transmission efficiency. In another specific example, when the first indication information includes a priority of the target packet and indicates that the priority of the target packet is medium, discarding of the target packet is prioritized, and when the first indication information includes a priority of the target packet and indicates that the priority of the target packet is high, transmission of the target packet is prioritized, so that data transmission can be optimized based on the priority of the target packet, thereby improving data transmission efficiency. When the first indication information is not received, transmission of the another packet may be prioritized, to ensure reliability of packet transmission, or discarding of the another packet is prioritized, to ensure transmission validity and save system resources.

In some embodiments, the second indication information indicates at least one of the following:
the target packet cannot be discarded, for example, even if the target packet exceeds preset time, the target packet cannot be discarded, so that when receiving no second indication information, the first protocol entity may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources;
the target packet is not discarded, for example, the target packet is not discarded after exceeding preset time, so that when receiving no the second indication information, the first protocol entity may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources;
the target packet is reserved, for example, the target packet is reserved after exceeding preset time, so that when receiving no second indication information, the first protocol entity may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources;
a delay of the target packet does not exceed a preset delay, so that when receiving no second indication information, the first protocol entity cannot learn whether the delay of the target packet exceeds the preset delay, and may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources;
transmission of the target packet can be completed within a preset delay, so that when receiving no second indication information, the first protocol entity cannot learn whether the transmission of the target packet can be completed in the preset delay, and the first protocol entity may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources;
feedback information corresponding to the target packet, including an acknowledgement (ACK) message or a negative acknowledgement (NACK) message, so that when receiving no second indication information, the first protocol entity cannot determine the feedback information corresponding to the target packet, and may prioritize transmission of the target packet, to ensure reliability of packet transmission, o the first protocol entity may prioritize discarding of the target packet, to ensure transmission validity and save system resource; and when receiving the second indication information, the first protocol entity may prioritize transmission of another packet, to ensure reliability of packet transmission, or the first protocol entity may prioritize discarding of another packet, to ensure transmission validity and save system resources;
a remaining delay of the target packet, where transmission or discarding of the target packet may be prioritized based on the remaining delay of the target packet, for example, when the remaining delay of the target packet reaches a specific preset value, it indicates that the target packet is to expire, and the preset value may be agreed upon in a protocol or configured by a network; or when the remaining delay of the target packet reaches another preset value, it indicates that the target packet has expired for a receive end; in this way, when receiving no second indication information, the first protocol entity cannot learn the remaining delay of the target packet, and may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources; and
a characteristic of the target packet, including importance, a priority, a dependency, a PDB/PSDB, a size, a packet error rate (PDU/PDU set error rate, PER/PSER), a delay, a quality of service (QOS) parameter (such as information related to a QoS flow identifier or a 5QI), and the like, so that when receiving no second indication information, the first protocol entity cannot learn the characteristic of the target packet and may prioritize transmission of the target packet, to ensure reliability of packet transmission, or the first protocol entity may prioritize discarding of the target packet, to ensure transmission validity and save system resources. When the second indication information is received, if a priority of the target packet in the second indication information is low, transmission of another packet may be prioritized, to ensure reliability of packet transmission, and if the priority of the target packet in the second indication information is high, discarding of another packet may be prioritized, to ensure transmission validity and save system resources.

In some embodiments, the preset delay includes at least one of the following:
a packet delay budget (PDB) or a packet set delay budget (PDU set delay budget, PSDB); and
a remaining PDB or a remaining PSDB.

In some embodiments, the remaining PDB or the remaining PSDB is a difference between a first parameter and a second parameter, and the first parameter may include any one of the following:
a packet delay requirement on an access network side;
a PDB or a PSDB of an access network;
a PDB or a PSDB; and
a packet delay requirement; and
the second parameter may include at least one of the following:
a delay of caching a packet in the second protocol entity; and
a PDB or PSDB requirement of the second protocol entity.

The PDB or the PSDB is a delay requirement of the terminal or a delay requirement of the terminal in a preset node, for example, a PDB or a PSDB of a radio access network, or a PDB or a PSDB of a core network.

In some embodiments, the target packet includes at least one of the following:
a PDCP service data unit SDU;
a PDCP protocol data unit PDU;
data in a PDCP buffer;
a packet corresponding to an RLC bearer, including: a protocol data unit (PDU), a protocol data unit set (PDU set), a frame, a burst, a slice, a picture, a group of picture (GOP), a group of protocol data unit sets (group of PDU set), a group of protocol data unit sets (group of PDU), and the like;
a packet corresponding to a MAC SDU, including: a PDU, a PDU set, a burst, a frame, a slice, a picture, a group of picture (GOP), a group of PDU set, a group of PDU, and the like; and
a packet corresponding to a MAC PDU, including: a PDU, a PDU set, a burst, a frame, a slice, a picture, a group of picture (GOP), a group of PDU set, a group of PDU, and the like.

In some embodiments, the first indication information or the second indication information may be included in an inter-layer primitive sent by the second protocol entity to the first protocol entity. In this way, transmission reliability of the first indication information and the second indication information can be ensured. The inter-layer primitive means that a primitive is used between different layer protocol entities for communication, and includes but is not limited to primitives such as request, response, confirm, and indication.

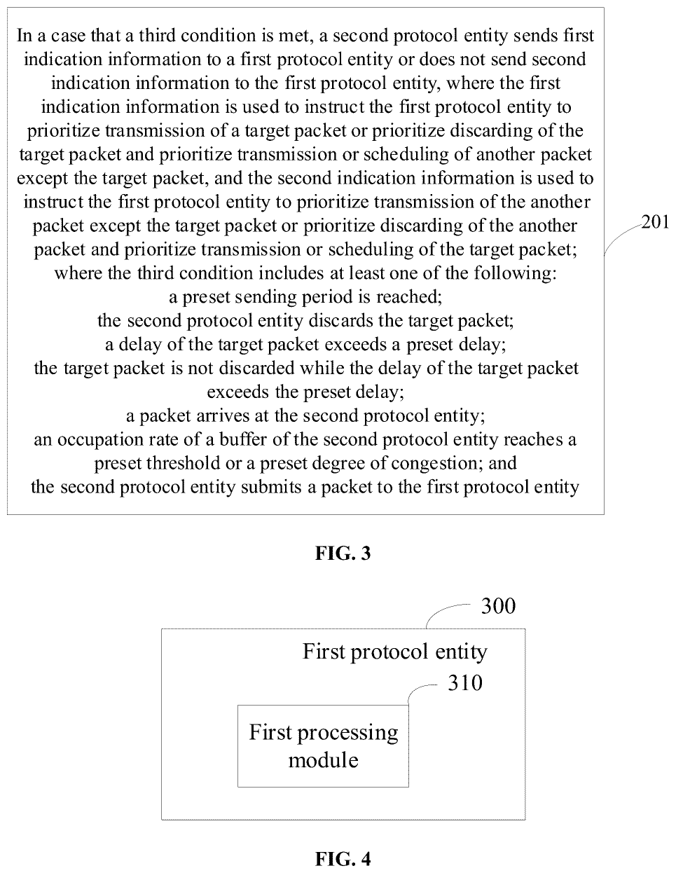

An embodiment of this application provides a packet processing method. As shown in FIG. 3, the method includes the following steps.

Step 201: In a case that a third condition is met, a second protocol entity sends first indication information to a first protocol entity or does not send second indication information to the first protocol entity, where the first indication information is used to instruct the first protocol entity to prioritize transmission of a target packet or prioritize discarding of the target packet, and the second indication information is used to instruct the first protocol entity to prioritize transmission of another packet except the target packet or prioritize discarding of the another packet; where
the third condition includes at least one of the following:
a preset sending period is reached, and the second protocol entity may send the first indication information to the first protocol entity based on the preset sending period, where the preset sending period is agreed upon in a protocol or configured by a network side device;
the second protocol entity discards the target packet, and after the second protocol entity discards the target packet, the second protocol entity may send the first indication information to the first protocol entity, to instruct the first protocol entity to prioritize discarding of the target packet;
a delay of the target packet exceeds a preset delay, and the second protocol entity may send the first indication information to the first protocol entity, to instruct the first protocol entity to prioritize discarding of the target packet
the target packet is not discarded while the delay of the target packet exceeds the preset delay, and the second protocol entity may send the first indication information to the first protocol entity, to instruct the first protocol entity to prioritize transmission of the target packet;
a packet arrives at the second protocol entity, and the second protocol entity may send the first indication information to the first protocol entity, to instruct the first protocol entity to prioritize transmission of the target packet;
an occupation rate of a buffer of the second protocol entity reaches a preset threshold or a preset degree of congestion, and the second protocol entity may send the first indication information to the first protocol entity, to instruct the first protocol entity to prioritize scheduling of the target packet; and
the second protocol entity submits a packet to the first protocol entity, and the second protocol entity may send the first indication information to the first protocol entity, to instruct the first protocol entity to prioritize scheduling of the target packet; where
the target packet is a packet corresponding to the first indication information or the second indication information; and
the second protocol entity is an upper-layer protocol entity of the first protocol entity, and the second protocol entity includes at least one of the following: an application layer entity, a non-access stratum NAS entity, a packet data convergence protocol PDCP entity, an RLC entity, or a MAC entity; and the first protocol entity includes at least one of the following: an RLC entity, a MAC entity, and a physical layer PHY entity.

In some embodiments, the method further includes:
in a case that a fourth condition is met, sending, by the second protocol entity, the second indication information to the first protocol entity, or not sending, by the second protocol entity, the first indication information to the first protocol entity; where
the fourth condition includes at least one of the following:
a preset sending period is reached, and the second protocol entity may send the second indication information to the first protocol entity based on the preset sending period, where the preset sending period is agreed upon in a protocol or configured by a network side device;
the second protocol entity reserves the target packet, and the second protocol entity may send the second indication information to the first protocol entity, to instruct the first protocol entity to prioritize scheduling of another packet or not discard the target packet or continue to reserve the target packet;
a delay of the target packet does not exceed a preset delay, and the second protocol entity may send the second indication information to the first protocol entity, to instruct the first protocol entity to prioritize scheduling of another packet or not discard the target packet or continue to reserve the target packet;
the target packet is discarded while the delay of the target packet exceeds the preset delay, and the second protocol entity may send the second indication information to the first protocol entity, to instruct the first protocol entity to prioritize transmission of another packet;
a packet does not arrive at the second protocol entity, and the second protocol entity may send the second indication information to the first protocol entity, to instruct the first protocol entity to prioritize scheduling of another packet;
an occupation rate of a buffer of the second protocol entity does not reach a preset threshold or a preset degree of congestion, and the second protocol entity may send the second indication information to the first protocol entity, to instruct the first protocol entity to prioritize scheduling of another packet or not discard the target packet or continue to reserve the target packet; and
the second protocol entity does not submit a packet to the first protocol entity, and the second protocol entity may send the second indication information to the first protocol entity, to instruct the first protocol entity to prioritize scheduling of another packet or not discard the target packet or continue to reserve the target packet.

In this embodiment, the target packet is a packet corresponding to the first indication information or the second indication information, or the target packet is a packet indicated by the first indication information or the second indication information, and a packet identifier of the target packet may be carried in the first indication information or the second indication information, so that the first protocol entity determines the target packet.

In some embodiments, the first indication information indicates at least one of the following:
the target packet can be discarded, so that the first protocol entity may prioritize discarding of the target packet based on the first indication information, thereby ensuring transmission validity and saving system resources; or the first protocol entity may prioritize transmission of the target packet, to ensure reliability of packet transmission; and when the first indication information is not received, the first protocol entity may prioritize transmission of the another packet, to ensure reliability of packet transmission, or the first protocol entity may prioritize discarding of the another packet, to ensure transmission validity and save system resources;
the target packet is discarded, that is, the second protocol entity has discarded the target packet, so that the first protocol entity may prioritize discarding of the target packet based on the first indication information, to ensure transmission validity and save system resources; or the first protocol entity may prioritize transmission of the target packet, to ensure reliability of packet transmission; and when the first indication information is not received, the first protocol entity may prioritize transmission of the another packet, to ensure reliability of packet transmission, or the first protocol entity may prioritize discarding of the another packet, to ensure transmission validity and save system resources;
a delay of the target packet exceeds a preset delay, which indicates that transmission of the target packet has been delayed, and the first protocol entity may prioritize discarding of the target packet based on the first indication information, to ensure transmission validity and save system resources; or the first protocol entity may prioritize transmission of the target packet, to ensure reliability of packet transmission; and when the first indication information is not received, the first protocol entity may prioritize transmission of the another packet, to ensure reliability of packet transmission, or the first protocol entity may prioritize discarding of the another packet, to ensure transmission validity and save system resources;
transmission of the target packet cannot be completed within a preset delay, which indicates that a delay of the target packet cannot be ensured, so that the first protocol entity may prioritize discarding of the target packet based on the first indication information, to ensure transmission validity and save system resources; or the first protocol entity may prioritize transmission of the target packet, to ensure reliability of packet transmission; and when the first indication information is not received, the first protocol entity may prioritize transmission of the another packet, to ensure reliability of packet transmission, or the first protocol entity may prioritize discarding of the another packet, to ensure transmission validity and save system resources;
feedback information corresponding to the target packet, including an acknowledgement message (ACK) message or a negative acknowledgement (NACK) message, where when the feedback information corresponding to the target packet is an ACK, discarding of the target packet may be prioritized, to save system resources, and when the feedback information corresponding to the target packet is a NACK, transmission of the target packet is prioritized, to ensure reliability of packet transmission; and when the first indication information is not received, transmission of the another packet may be prioritized, to ensure reliability of packet transmission, or discarding of the another packet is prioritized, to ensure transmission validity and save system resources; and
a remaining delay of the target packet, where transmission of the target packet may be prioritized or discarding of the target packet may be prioritized based on the remaining delay of the target packet, for example, when the remaining delay of the target packet reaches a specific preset value, it indicates that this target packet is to expire, and transmission of this target packet may be prioritized, to ensure reliability of packet transmission, where the preset value may be agreed upon in a protocol or configured by a network; or when the remaining delay of the target packet reaches another preset value, it indicates that this target packet has already expired for a receive end, and to ensure transmission validity and save system resources, the target packet may be discarded; and when the first indication information is not received, transmission of the another packet may be prioritized, to ensure reliability of packet transmission, or discarding of the another packet is prioritized, to ensure transmission validity and save system resources; and
a characteristic of the target packet, including importance, a priority, a dependency, a PDB/PSDB, a size, a packet error rate (PDU/PDU set error rate, PER/PSER), a delay, a quality of service (QOS) parameter (such as information related to a QoS flow ID or a 5QI), and the like. In a specific example, when the first indication information includes importance of the target packet and indicates that the importance of the target packet is medium, discarding of the target packet is prioritized, and when the first indication information includes importance of the target packet and indicates that the importance of the target packet is high, transmission of the target packet is prioritized, so that data transmission can be optimized based on the importance of the target packet, thereby improving data transmission efficiency. In another specific example, when the first indication information includes a priority of the target packet and indicates that the priority of the target packet is medium, discarding of the target packet is prioritized, and when the first indication information includes a priority of the target packet and indicates that the priority of the target packet is high, transmission of the target packet is prioritized, so that data transmission can be optimized based on the priority of the target packet, thereby improving data transmission efficiency. When the first indication information is not received, transmission of the another packet may be prioritized, to ensure reliability of packet transmission, or discarding of the another packet is prioritized, to ensure transmission validity and save system resources.

In some embodiments, the second indication information indicates at least one of the following:
the target packet cannot be discarded, for example, even if the target packet exceeds preset time, the target packet cannot be discarded, so that when receiving no second indication information, the first protocol entity may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources;
the target packet is not discarded, for example, the target packet is not discarded after exceeding preset time, so that when receiving no the second indication information, the first protocol entity may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources;
the target packet is reserved, for example, the target packet is reserved after exceeding preset time, so that when receiving no second indication information, the first protocol entity may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources;
a delay of the target packet does not exceed a preset delay, so that when receiving no second indication information, the first protocol entity cannot learn whether the delay of the target packet exceeds the preset delay, and may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources;
transmission of the target packet can be completed within a preset delay, so that when receiving no second indication information, the first protocol entity cannot learn whether the transmission of the target packet can be completed in the preset delay, and the first protocol entity may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources;
feedback information corresponding to the target packet, including an acknowledgement (ACK) message or a negative acknowledgement (NACK) message, so that when receiving no second indication information, the first protocol entity cannot determine the feedback information corresponding to the target packet, and may prioritize transmission of the target packet, to ensure reliability of packet transmission, o the first protocol entity may prioritize discarding of the target packet, to ensure transmission validity and save system resource; and when receiving the second indication information, the first protocol entity may prioritize transmission of another packet, to ensure reliability of packet transmission, or the first protocol entity may prioritize discarding of another packet, to ensure transmission validity and save system resources;
a remaining delay of the target packet, where transmission or discarding of the target packet may be prioritized based on the remaining delay of the target packet, for example, when the remaining delay of the target packet reaches a specific preset value, it indicates that the target packet is to expire, and the preset value may be agreed upon in a protocol or configured by a network; or when the remaining delay of the target packet reaches another preset value, it indicates that the target packet has expired for a receive end; in this way, when receiving no second indication information, the first protocol entity cannot learn the remaining delay of the target packet, and may prioritize transmission of the target packet, to ensure reliability of packet transmission, or the first protocol entity may prioritize discarding of the target packet, to ensure transmission validity and save system resources; and when receiving the second indication information, the first protocol entity may prioritize transmission of another packet, to ensure reliability of packet transmission, or the first protocol entity may prioritize discarding of another packet, to ensure transmission validity and save system resources; and
a characteristic of the target packet, including importance, a priority, a dependency, a PDB/PSDB, a size, a packet error rate (PDU/PDU set error rate, PER/PSER), a delay, a quality of service (QOS) parameter (such as information related to a QoS flow identifier or a 5QI), and the like, so that when receiving no second indication information, the first protocol entity cannot learn the characteristic of the target packet and may prioritize transmission of the target packet, to ensure reliability of packet transmission, or the first protocol entity may prioritize discarding of the target packet, to ensure transmission validity and save system resources. When the second indication information is received, if a priority of the target packet in the second indication information is low, transmission of another packet may be prioritized, to ensure reliability of packet transmission, and if the priority of the target packet in the second indication information is high, discarding of another packet may be prioritized, to ensure transmission validity and save system resources.

In some embodiments, the preset delay includes at least one of the following:
a packet delay budget PDB or a packet set delay budget PSDB; and
a remaining PDB or a remaining PSDB.

In some embodiments, the remaining PDB or the remaining PSDB is a difference between a first parameter and a second parameter, and the first parameter includes any one of the following:
a packet delay requirement on an access network side;
a PDB or a PSDB of an access network;
a PDB or a PSDB; and
a packet delay requirement; and
the second parameter includes at least one of the following:
a delay of caching a packet in the second protocol entity; and
a PDB or PSDB requirement of the second protocol entity.

The PDB or the PSDB is a delay requirement of the terminal or a delay requirement of the terminal in a preset node, for example, a PDB or a PSDB of a radio access network, or a PDB or a PSDB of a core network.

In some embodiments, the target packet includes at least one of the following:
a PDCP service data unit SDU;
a PDCP protocol data unit PDU;
data in a PDCP buffer;
a packet corresponding to an RLC bearer, including: a protocol data unit (PDU), a protocol data unit set (PDU set), a frame, a burst, a slice, a picture, a group of picture (GOP), a group of protocol data unit sets (group of PDU set), a group of protocol data unit sets (group of PDU), and the like;
a packet corresponding to a MAC SDU, including: a PDU, a PDU set, a burst, a frame, a slice, a picture, a group of picture (GOP), a group of PDU set, a group of PDU, and the like; and
a packet corresponding to a MAC PDU, including: a PDU, a PDU set, a burst, a frame, a slice, a picture, a group of picture (GOP), a group of PDU set, a group of PDU, and the like.

In some embodiments, the first indication information or the second indication information may be included in an inter-layer primitive sent by the second protocol entity to the first protocol entity. In this way, transmission reliability of the first indication information and the second indication information can be ensured. The inter-layer primitive means that a primitive is used between different layer protocol entities for communication, and includes but is not limited to primitives such as request, response, confirm, and indication.

The packet processing method provided in the embodiments of this application may be performed by a packet processing apparatus. In the embodiments of this application, that the packet processing apparatus performs the packet processing method is used as an example to describe the packet processing apparatus provided in the embodiments of this application.

An embodiment of this application provides a packet processing apparatus. As shown in FIG. 4, the apparatus is applied to a first protocol entity 300 and includes:
a first processing module 310, configured to: in a case that a first condition is met, prioritize transmission of a target packet or prioritize discarding of the target packet; where
the first condition includes at least one of the following:
a first protocol entity receives first indication information from a second protocol entity; and
the first protocol entity does not receive second indication information from the second protocol entity; where
the target packet is a packet corresponding to the first indication information or the second indication information; and
the second protocol entity is an upper-layer protocol entity of the first protocol entity, the second protocol entity includes at least one of the following: an application layer entity, a NAS entity, a PDCP entity, an RLC entity, and a MAC entity, and the first protocol entity includes at least one of the following: an RLC entity, a MAC entity, and a PHY entity.

In this embodiment of this application, the first protocol entity schedules and processes the target packet based on the first indication information or the second indication information from the second protocol entity, so that scheduling and processing of the target packet can be optimized, and data transmission efficiency can be improved, thereby improving a capacity of a communication system and reducing power consumption of a terminal.

In some embodiments, the first processing module 310 is specifically configured to perform at least one of the following:
scheduling a new transmission;
discarding the target packet;
prioritizing scheduling of the target packet;
increasing a priority of a logical channel LCH of the target packet;
adjusting the target packet to a higher-priority LCH; and
adjusting a modulation and coding scheme MCS level of the target packet.

In some embodiments, the first processing module 310 is configured to: in a case that a second condition is met, prioritize transmission of another packet except the target packet or prioritize discarding of the another packet; where
the second condition includes at least one of the following:
the first protocol entity does not receive the first indication information from the second protocol entity; and
the first protocol entity receives the second indication information from the second protocol entity.

In some embodiments, the first processing module 310 is specifically configured to perform at least one of the following:
scheduling a retransmission;
reserving the target packet;
not discarding the target packet;
prioritizing scheduling of the another packet;
decreasing a priority of an LCH of the target packet;
adjusting the target packet to a lower-priority LCH; and
adjusting an MCS level of the target packet.

In some embodiments, the first indication information indicates at least one of the following:

the target packet is capable of being discarded;
the target packet is discarded;
a delay of the target packet exceeds a preset delay;
transmission of the target packet is incapable of being completed within the preset delay;
feedback information corresponding to the target packet;
a remaining delay of the target packet; and
a characteristic of the target packet.

In some embodiments, the second indication information indicates at least one of the following:
the target packet is incapable of being discarded;
the target packet is not discarded;
the target packet is reserved;
a delay of the target packet does not exceed a preset delay;
transmission of the target packet is capable of being completed within the preset delay;
feedback information corresponding to the target packet;
a remaining delay of the target packet; and
a characteristic of the target packet.

In some embodiments, the preset delay includes at least one of the following:
a packet delay budget PDB or a packet set delay budget PSDB; and
a remaining PDB or a remaining PSDB.

In some embodiments, the remaining PDB or the remaining PSDB is a difference between a first parameter and a second parameter, and the first parameter includes any one of the following:
a packet delay requirement on an access network side;
a PDB or a PSDB of an access network;
a PDB or a PSDB; and
a packet delay requirement; and
the second parameter includes at least one of the following:
a delay of caching a packet in the second protocol entity; and
a PDB or PSDB requirement of the second protocol entity.

In some embodiments, the target packet includes at least one of the following:
a PDCP service data unit SDU;
a PDCP protocol data unit PDU;
data in a PDCP buffer;
a packet corresponding to an RLC bearer;
a packet corresponding to a MAC SDU; and
a packet corresponding to a MAC PDU.

In some embodiments, the first indication information or the second indication information is included in an inter-layer primitive sent by the second protocol entity to the first protocol entity.

An embodiment of this application provides a packet processing apparatus. As shown in FIG. 5, the apparatus is applied to a second protocol entity 400 and includes:
a second processing module 410, configured to: in a case that a third condition is met, send first indication information to a first protocol entity or skip sending second indication information to the first protocol entity, where the first indication information is used to instruct the first protocol entity to prioritize transmission of a target packet or prioritize discarding of the target packet, and the second indication information is used to instruct the first protocol entity to prioritize transmission of another packet except the target packet or prioritize discarding of the another packet; where
the third condition includes at least one of the following:
a preset sending period is reached;
a second protocol entity discards the target packet;
a delay of the target packet exceeds a preset delay;
the target packet is not discarded while the delay of the target packet exceeds the preset delay;
a packet arrives at the second protocol entity;
an occupation rate of a buffer of the second protocol entity reaches a preset threshold or a preset degree of congestion; and
the second protocol entity submits a packet to the first protocol entity; where
the target packet is a packet corresponding to the first indication information or the second indication information; and
the second protocol entity is an upper-layer protocol entity of the first protocol entity, the second protocol entity includes at least one of the following: an application layer entity, a non-access stratum NAS entity, a PDCP entity, an RLC entity, and a MAC entity, and the first protocol entity includes at least one of the following: an RLC entity, a MAC entity, and a PHY entity.

In some embodiments, the second processing module 410 is configured to: in a case that a fourth condition is met, send the second indication information to the first protocol entity or skip sending the first indication information to the first protocol entity where
the fourth condition includes at least one of the following:
a preset sending period is reached;
the second protocol entity reserves the target packet;
a delay of the target packet does not exceed a preset delay;
the target packet is discarded while the delay of the target packet exceeds the preset delay;
a packet does not arrive at the second protocol entity;
an occupation rate of a buffer of the second protocol entity does not reach a preset threshold or a preset degree of congestion; and
the second protocol entity does not submit a packet to the first protocol entity.

In some embodiments, the first indication information indicates at least one of the following:
the target packet is capable of being discarded;
the target packet is discarded;
a delay of the target packet exceeds a preset delay;
transmission of the target packet is incapable of being completed within the preset delay;
feedback information corresponding to the target packet;
a remaining delay of the target packet; and
a characteristic of the target packet.

In some embodiments, the second indication information indicates at least one of the following:
the target packet is incapable of being discarded;
the target packet is not discarded;
the target packet is reserved;
a delay of the target packet does not exceed a preset delay;
transmission of the target packet is capable of being completed within the preset delay;
feedback information corresponding to the target packet;
a remaining delay of the target packet; and
a characteristic of the target packet.

In some embodiments, the preset delay includes at least one of the following:
a packet delay budget PDB or a packet set delay budget PSDB; and
a remaining PDB or a remaining PSDB.

In some embodiments, the remaining PDB or the remaining PSDB is a difference between a first parameter and a second parameter, and the first parameter includes any one of the following:
a packet delay requirement on an access network side;
a PDB or a PSDB of an access network;
a PDB or a PSDB; and
a packet delay requirement; and
the second parameter includes at least one of the following:
a delay of caching a packet in the second protocol entity; and
a PDB or PSDB requirement of the second protocol entity.

In some embodiments, the target packet includes at least one of the following:
a PDCP service data unit SDU;
a PDCP protocol data unit PDU;
data in a PDCP buffer;
a packet corresponding to an RLC bearer;
a packet corresponding to a MAC SDU; and
a packet corresponding to a MAC PDU.

In some embodiments, the first indication information or the second indication information is included in an inter-layer primitive sent by the second protocol entity to the first protocol entity.

The packet processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The packet processing apparatus provided in this embodiment of this application can implement the processes implemented in the method embodiments in FIG. 2 and FIG. 3, and a same technical effect is achieved. To avoid repetition, details are not described herein again.

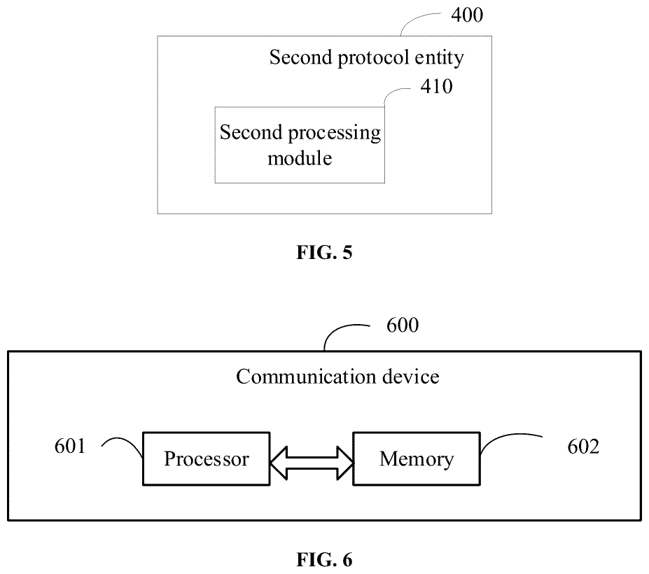

Optionally, as shown in FIG. 6, an embodiment of this application further provides a communication device 600, including a processor 601 and a memory 602, and the memory 602 stores a program or instructions capable of running on the processor 601. For example, in a case that the communication device 600 is a network side device, when the program or the instructions are executed by the processor 601, the steps of the foregoing embodiment of the packet processing method are implemented, and a same technical effect can be achieved. In a case that the communication device 600 is a network side device, when the program or the instructions are executed by the processor 601, the steps of the foregoing embodiment of the packet processing method are implemented, and a same technical effect can be achieved. To avoid repetition, details are not described herein again.

An embodiment of this application further provides a readable storage medium. The readable storage medium stores a program or instructions, and when the program or the instructions are executed by a processor, the steps of the foregoing embodiment of the packet processing method are implemented, and a same technical effect can be achieved. To avoid repetition, details are not described herein again.

The processor is a processor in the terminal in the foregoing embodiments. The readable storage medium includes a computer-readable storage medium, such as a computer read-only memory (ROM), a random access memory (RAM), a magnetic disk, an optical disc, or the like.

An embodiment of this application further provides a chip. The chip includes a processor and a communication interface, the communication interface is coupled to the processor, and the processor is configured to run a program or an instruction to implement the processes of the foregoing embodiments of the packet processing method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the foregoing embodiment of the packet processing method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A packet processing method, comprising:
in a case that a first condition is met, prioritizing, by a first protocol entity, transmission of a target packet, or prioritizing, by the first protocol entity, discarding of the target packet; wherein
the first condition comprises at least one of the following:
the first protocol entity receives first indication information from a second protocol entity; or
the first protocol entity does not receive second indication information from the second protocol entity; wherein
the target packet is a packet corresponding to the first indication information or the second indication information; and
the second protocol entity is an upper-layer protocol entity of the first protocol entity.

2. The packet processing method according to claim 1, wherein the second protocol entity comprises at least one of the following: an application layer entity, a non-access stratum (NAS) entity, a packet data convergence protocol (PDCP) entity, a radio link control (RLC) entity, or a medium access control (MAC) entity, and the first protocol entity comprises at least one of the following: an RLC entity, a MAC entity, or a physical layer (PHY) entity.

3. The packet processing method according to claim 1, wherein the prioritizing, by a first protocol entity, transmission of a target packet, or prioritizing, by the first protocol entity, discarding of the target packet comprises:
scheduling a new transmission;
discarding the target packet;
prioritizing scheduling of the target packet;
increasing a priority of a logical channel (LCH) of the target packet;
adjusting the target packet to a higher-priority LCH; and
adjusting a modulation and coding scheme (MCS) level of the target packet.

4. The packet processing method according to claim 1, wherein the method further comprises:
in a case that a second condition is met, prioritizing, by the first protocol entity, transmission of another packet except the target packet, or prioritizing, by the first protocol entity, discarding of the another packet; wherein
the second condition comprises at least one of the following:
the first protocol entity does not receive the first indication information from the second protocol entity; or
the first protocol entity receives the second indication information from the second protocol entity.

5. The packet processing method according to claim 4, wherein the prioritizing, by the first protocol entity, transmission or discarding of the another packet comprises:
scheduling a retransmission;
reserving the target packet;
not discarding the target packet;
prioritizing scheduling of the another packet;
decreasing a priority of an LCH of the target packet;
adjusting the target packet to a lower-priority LCH; and
adjusting an MCS level of the target packet.

6. The packet processing method according to claim 1, wherein the first indication information indicates at least one of the following:
the target packet is capable of being discarded;
the target packet is discarded;
a delay of the target packet exceeds a preset delay;
transmission of the target packet is incapable of being completed within the preset delay;
feedback information corresponding to the target packet;
a remaining delay of the target packet; or
a characteristic of the target packet.

7. The packet processing method according to claim 1, wherein the second indication information indicates at least one of the following:
the target packet is incapable of being discarded;
the target packet is not discarded;
the target packet is reserved;
a delay of the target packet does not exceed a preset delay;
transmission of the target packet is capable of being completed within the preset delay;
feedback information corresponding to the target packet;
a remaining delay of the target packet; or
a characteristic of the target packet.

8. The packet processing method according to claim 1, wherein the target packet comprises at least one of the following:
a PDCP service data unit (SDU);
a PDCP protocol data unit (PDU);
data in a PDCP buffer;
a packet corresponding to an RLC bearer;
a packet corresponding to a MAC SDU; or
a packet corresponding to a MAC PDU.

9. The packet processing method according to claim 1, wherein the first indication information or the second indication information is comprised in an inter-layer primitive sent by the second protocol entity to the first protocol entity.

10. A packet processing method, comprising:
in a case that a third condition is met, sending, by a second protocol entity, first indication information to a first protocol entity, or skipping sending, by the second protocol entity, second indication information to the first protocol entity, wherein the first indication information is used to instruct the first protocol entity to prioritize transmission of a target packet or prioritize discarding of the target packet, and the second indication information is used to instruct the first protocol entity to prioritize transmission of another packet except the target packet or prioritize discarding of the another packet; wherein
the third condition comprises at least one of the following:
a preset sending period is reached;
the second protocol entity discards the target packet;
a delay of the target packet exceeds a preset delay;
the target packet is not discarded while the delay of the target packet exceeds the preset delay;
a packet arrives at the second protocol entity;
an occupation rate of a buffer of the second protocol entity reaches a preset threshold or a preset degree of congestion; or
the second protocol entity submits a packet to the first protocol entity; wherein
the target packet is a packet corresponding to the first indication information or the second indication information; and
the second protocol entity is an upper-layer protocol entity of the first protocol entity.

11. The packet processing method according to claim 10, wherein the second protocol entity comprises at least one of the following: an application layer entity, a non-access stratum (NAS) entity, a packet data convergence protocol (PDCP) entity, a radio link control (RLC) entity, or a medium access control (MAC) entity, and the first protocol entity comprises at least one of the following: an RLC entity, a MAC entity, or a physical layer (PHY) entity.

12. The packet processing method according to claim 10, wherein the method further comprises:
in a case that a fourth condition is met, sending, by the second protocol entity, the second indication information to the first protocol entity, or skipping sending, by the second protocol entity, the first indication information to the first protocol entity; wherein
the fourth condition comprises at least one of the following:
a preset sending period is reached;
the second protocol entity reserves the target packet;
a delay of the target packet does not exceed a preset delay;
the target packet is discarded while the delay of the target packet exceeds the preset delay;
a packet does not arrive at the second protocol entity;
an occupation rate of a buffer of the second protocol entity does not reach a preset threshold or a preset degree of congestion; or
the second protocol entity does not submit a packet to the first protocol entity.

13. The packet processing method according to claim 10, wherein the first indication information indicates at least one of the following:
the target packet is capable of being discarded;
the target packet is discarded;
a delay of the target packet exceeds a preset delay;
transmission of the target packet is incapable of being completed within the preset delay;
feedback information corresponding to the target packet;
a remaining delay of the target packet; or
a characteristic of the target packet.

14. The packet processing method according to claim 10, wherein the second indication information indicates at least one of the following:
the target packet is incapable of being discarded;
the target packet is not discarded;
the target packet is reserved;
a delay of the target packet does not exceed a preset delay;
transmission of the target packet is capable of being completed within the preset delay;
feedback information corresponding to the target packet;
a remaining delay of the target packet; or
a characteristic of the target packet.

15. The packet processing method according to claim 10, wherein the target packet comprises at least one of the following:
a PDCP service data unit (SDU);
a PDCP protocol data unit (PDU);
data in a PDCP buffer;
a packet corresponding to an RLC bearer;
a packet corresponding to a MAC SDU; or
a packet corresponding to a MAC PDU.

16. The packet processing method according to claim 10, wherein the first indication information or the second indication information is comprised in an inter-layer primitive sent by the second protocol entity to the first protocol entity.

17. A packet processing apparatus, wherein the packet processing apparatus is a first protocol entity, comprising a processor and a memory, wherein the memory stores a program or instructions capable of running on the processor, wherein the program or the instructions, when executed by the processor, cause the processor to perform:
in a case that a first condition is met, prioritizing transmission of a target packet, or prioritizing, by the first protocol entity, discarding of the target packet; wherein
the first condition comprises at least one of the following:
the first protocol entity receives first indication information from a second protocol entity; or
the first protocol entity does not receive second indication information from the second protocol entity; wherein
the target packet is a packet corresponding to the first indication information or the second indication information; or
the second protocol entity is an upper-layer protocol entity of the first protocol entity.

18. A packet processing apparatus, wherein the packet processing apparatus is a first protocol entity, comprising a processor and a memory, wherein the memory stores a program or instructions capable of running on the processor, and when the program or the instructions are executed by the processor, the steps of the packet processing method according to claim 10 are implemented.

19. A non-transitory readable storage medium, wherein the non-transitory readable storage medium stores a program or instructions, and when the program or the instructions are executed by the processor, the steps of the packet processing method according to claim 1 are implemented.

20. A non-transitory readable storage medium, wherein the readable storage medium stores a program or instructions, and when the program or the instructions are executed by the processor, the steps of the packet processing method according to claim 10 are implemented.
